(19) United States
(12) Patent Application Publication
(10) Pub. No.: US 2024/0388751 A1
(43) Pub. Date: Nov. 21, 2024

(54) METHODS AND SYSTEMS FOR CONTENT SEGMENT MODIFICATION

(71) Applicant: Comcast Cable Communications, LLC, Philadelphia, PA (US)

(72) Inventor: Christopher LINTZ, Denver, CO (US)

(21) Appl. No.: 18/317,391

(22) Filed: May 15, 2023

(51) Int. Cl. H04N 21/258; H04N 21/231

(52) U.S. Cl. CPC H04N 21/25866; H04N 21/23113

(57) ABSTRACT

Systems and methods are described herein for compaction of uniquely recorded video segments. A particular content segment can be stored as either different versions, or with other content segments in the DVR system (e.g., as aggregated content). Aggregated content can also include system level data objects, which can store information associated with the content segments and can be used for the recreation of the content segments. When a request for deletion is received by the DVR system, a compactor can determine whether a number of deletion requests for content segments of the aggregated content is met. If the threshold is met, the compactor can compact the aggregated content to remove the content segments indicated by the request for deletion(s), which can then be stored in the DVR system. This compaction can reduce wasted storage in the DVR system, and can implement efficient processing or compaction resources of the DVR system.

### BACKGROUND

In a cloud or network content providing system (e.g., a digital video recorder (DVR) system), content may be recorded or stored on a service provider's servers for the requesting user. However, there may be cases where a user device requests that the recorded content be deleted, such as when a user chooses to delete the recording. In some cases, where the recorded content is stored together with other recorded content, the system may need to rewrite the entire aggregation of content (e.g., while deleting the recorded content according to the deletion request). This can waste processing resources of the content providing system. Accordingly, there is a need for more efficient techniques for storage utilization in content providing systems.

### SUMMARY

Systems and methods are described herein for storage and modification of uniquely recorded content (e.g., video) segments. A particular content segment can be stored as either different versions, or with other content segments in the content providing system (e.g., as an aggregated content). When a request for deletion is received by the content providing system, a compactor can optionally determine whether a number of deletion requests for particular content segments of the aggregated content is met. If the threshold is met, the compactor can compact the aggregated content to remove the particular content segments indicated by the request for deletion(s), which can then be stored in the content providing system. The aggregated content can also include system level data objects, which can contain information related to the particular content segments, and can be used to recreate the particular content segments stored in the aggregated content (e.g., as opposed to reading the particular content segments prior to compaction). Thus, the system level data objects can be used to overwrite new aggregated content object, where the particular content segments marked or flagged for deletion are ignored during the overwrite. This compaction can reduce wasted storage in the content providing system, and can implement efficient processing or compaction resources of the content providing system.

### BRIEF DESCRIPTION OF THE DRAWINGS

The following drawings show generally, by way of example, but not by way of limitation, various examples discussed in the present disclosure. In the drawings:

FIG. 1 shows an example system;

FIG. 2 shows example content segments;

FIG. 3 shows example content segments;

FIG. 4 shows an example method;

FIG. 5 shows an example method;

FIG. 6 shows an example method;

FIG. 7 shows an example method; and

FIG. 8 shows an example computing device.

### DETAILED DESCRIPTION OF ILLUSTRATIVE EMBODIMENTS

Systems and methods are described herein for compaction of uniquely recorded video segments. The systems and methods described herein provide for efficient storage and compaction processes for recorded content segments. A user may request a content segment to be recorded. The content providing system can record the segment and store the segment with other versions of the content segment, with other content segments, or both (as aggregated content). The aggregated content can also include system level data objects, which can be used for recreating the content segments. A compactor of the content providing system can compact the aggregated content when a number of deletion requests for content segments of the aggregated content is received by the content providing system. Compacting can include rewriting the aggregated content without the content segments that are requested to be deleted, based on the system level data objects. The compaction techniques described herein can provide for efficient storage of content, and efficient use of processing (e.g., compaction) resources of the content providing system.

In comparison, conventional storage processes for content providing systems may delete a content segment upon receipt of a user request to delete the content segment. In the case where the content segment is stored as an aggregated content segment (e.g., with other content segments), the content providing system may delete and rewrite the aggregated content segment upon receipt of a user request to delete the content segment, without regard to characteristics of the aggregated content segment or previous deletion requests. This conventional deleting and rewriting of content segments may expend a significant amount of processing and memory resources of the content providing system, particularly in cases where the aggregated content segment may comprise hundred or thousands of content segments.

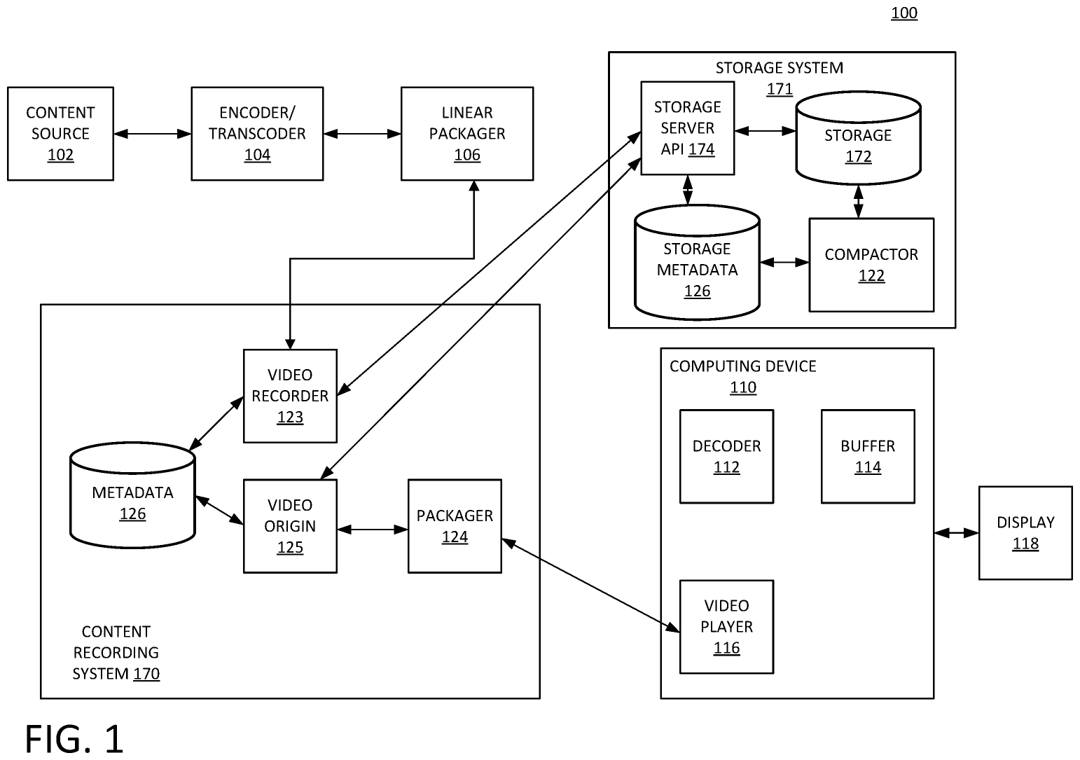

FIG. 1 shows system 100 for delivering content. The example system 100 may comprise a content source 102, an encoder/transcoder 104, a linear packager 106, a content delivery system 170, a storage system 171, a scheduler 180, and a computing device 110. The techniques for video processing described herein are applicable to any content delivery method including but not limited to Dynamic Adaptive Streaming over HTTP (DASH), HTTP Live Streaming (HLS), the quadrature amplitude modulation (QAM) standard, and/or adaptive bit rate (ABR) streaming.

The computing device 110 may comprise a television, a monitor, a laptop, a desktop, a smart phone, a set-top box, a streaming-video player, a cable modem, a gateway, a tablet, a wearable computing device, a mobile computing device, any computing device configured to receive and/or render content, the like, and/or any combination of the foregoing. The computing device 110 may comprise a decoder 112, a buffer 114, and a video player 116. The computing device 110 (e.g., the video player 116) may be communicatively connected to a display 118. The display 118 may be a separate and discrete component from the computing device 110, such as a television display connected to a set-top box. The display 118 may be integrated with the computing device 110. The decoder 112, the video player 116, the buffer 114, and the display 118 may be realized in a single device, such as a laptop or mobile device. The decoder 112 may decompress/decode encoded video data. The encoded video data may be received from the encoder/transcoder 104, the linear packager 106, or the content delivery system 170.

The content source 102 may comprise a source feed of content from a provider. For example, the content source 102 may comprise a broadcast source, a service provider (e.g., a cable television service provider), a headend, a video on-demand server, a cable modem termination system, the like, and/or any combination of the foregoing. The content source 102 may send content to the encoder/transcoder 104. The content may comprise for example, a program, a television show, a movie, a sports event broadcast, or the like. The content may comprise video frames or other images. For example, the content may comprise video frames in a Moving Picture Experts Group (MPEG) Single Program Transport Stream (MPEG-SPTS). The video frames may comprise pixels. A pixel may comprise the smallest controllable element of a video frame. The video frame may comprise bits for controlling each associated pixel. A portion of the bits for an associated pixel may control a luma value (e.g., light intensity) of each associated pixel. A portion of the bits for an associated pixel may control one or more chrominance value (e.g., color) of the pixel.

The content source 102 may receive requests for the content from the encoder/transcoder 104, the packager 106, the computing device 110, or the content delivery system 170. The content source 102 may send content to the encoder/transcoder 104 based on a request for video from the encoder/transcoder 104, the packager 106, the computing device 110, or the content delivery system 170. The content may comprise uncompressed video data or a content stream such as an MPEG-SPTS.

The encoder/transcoder 104 may comprise an encoder, which may encode uncompressed video data received from the content source 102. The terms transcoder and encoder may be used interchangeably herein. The terms transcode and encode may be used interchangeably herein. The encoder/transcoder 104 may receive content from the content source 102. The content may be in any one of a variety of formats, such as, for example, H.264, MPEG-4 Part 2, or MPEG-2. The encoder/transcoder 104 may convert the content from one video format to another video format, such as one format compatible with the playback devices of the service provider's users (e.g., computing device 110). The encoder/transcoder 104 may additionally segment the content into a plurality of segments. For example, content may be segmented into a series of 2-second segments.

When uncompressed video data is received, the encoder may encode the video (e.g., into a compressed format) using a compression technique prior to transmission. The content source 102 and the encoder/transcoder 104 may be co-located at a premises, located at separate premises, or associated with separate instances in the cloud. The encoder 104 may comprise any type of encoder including but not limited to: H.264/MPEG-AVC, H.265/MPEG-HEVC, MPEG-5 EVC, H.266/MPEG-VVC, AV1, VP9, Global motion compensation (GMC), etc. The encoder/transcoder 104 may transcode the content into one or more output streams. The one or more output streams may comprise video encoded with different resolutions and/or different bit rates.

The linear packager 106 may receive the content from the encoder/transcoder 104 or the content delivery system 170. For example, the linear packager 106 may receive the one or more output streams from the encoder/transcoder 104. The linear packager 106 may determine how the content is to be segmented and put together for delivery to the content delivery system 170.

The packager 106 may generate one or more ABR streams in different ABR streaming formats. The one or more ABR streams may comprise segments or fragments of video and the manifest. The manifest may indicate availability of the ABR stream and segments/fragments and information for requesting the segments/fragments (e.g., via a URL). The packager 106 may send the one or more ABR streams to the content delivery system 170.

The content delivery system 170 may comprise one or more computing devices such as a video recording system 123, packager 124, video origin 125, and metadata storage 126. The video recording system 123 may receive content from the linear packager 106 and may record or store the content in the content delivery system 170. For example, the video recording system 123 may record the content from the linear packager 106, and may store the recorded content in storage system 171. Additionally, the video recording system 123 manages metadata associated with the recorded content. The video recording system 123 may extract or generate metadata for a recorded content segment and store the metadata within metadata storage 126.

The packager 124 may package content segments for delivery to the computing device 110. For example, the packager 124 may receive a request for content from the computing device 110, and may retrieve content segments according to the request. The packager 124 may determine how the content is to be segmented and put together for delivery to and eventual playback by the computing device 110. As part of this process, the packager 124 may segment the content (such as in the event that the content has not yet been segmented) or may re-segment the content (such as in the event that the content had been previously segmented). The packager 124 may additionally insert one or more cues or markers into the content segments at which one or more additional segments, such as segments comprising an advertisement, may be inserted by an upstream client, server, or logical module, such as a component of the content delivery system 170.

The video origin 125 may serve requests for the packager 124. The video origin 125 may also generate and send manifests associated with a content profile or particular content segments. The video origin 125 may create a manifest file associated with the content. For example, the manifest may comprise a DASH manifest. The manifest may comprise information describing various aspects of the associated content that may be useful for the computing device 110 to playback the content and/or for the content delivery system 170 to store and retrieve the content. For example, the manifest may indicate the availability of the segments comprising the content, the length of each segment, the number of segments, and/or the proper ordering of the segments necessary to cause playback of the content. The manifest may further include a network location (e.g., a hyper-text transfer protocol (HTTP) uniform resource locater (URL) link or other universal resource identifier (URI)) for each segment from which the segment may be downloaded, accessed, or retrieved. For example, the network location may indicate a location in storage 172.

The network locations included within the manifest may indicate more than one location or source. For example, the network location for segments corresponding to the content may reference a storage location while the network location for segments corresponding to an inserted advertisement may reference a location from outside the system 100 (e.g., at an advertising server). The manifest may describe multiple versions (e.g., different quality levels) of the content, including corresponding information on those segments. For example, manifest may describe multiple bit rate and/or resolution versions of the content. The manifest may be provided, such as by the packager 124, to the computing device 110 in response to a request to receive stored content. The computing device 110 may use the manifest file to determine the segments required to play the content or a segment/portion of the content and subsequently download the required segments using the network locations specified in the manifest file.

The scheduler 180 may coordinate the recording and deleting of stored content. For example, the scheduler 180 maybe in communication with the computing device 110 (e.g., via the video player 116), and may receive requests for recording content segments from the computing device 110. The scheduler 180 may instruct the content delivery system 170 (e.g., via the video recorder 123) to record the requested content segment. Likewise, the scheduler 180 may receive requests from the computing device 110 to delete stored content segments. The scheduler 180 may instruct the storage system 171 to delete the content segment, or to inform the storage system 171 of the computing device's request for deletion for the content segment.

The content delivery system 170 (e.g., the video recorder 123) may receive a request to record content from the computing device 110 (e.g., via the scheduler 180). The request may be sent via HTTP. The video recording system 123 may authorize/authenticate the request and/or the computing device 110 from which the request originated. The request for recording content may comprise a request for a channel, a recorded program, a video on-demand asset, a website address, a video asset associated with a streaming service, the like, and/or any combination of the foregoing. The video recording system 123 may record the requested content and send the content to storage system 171. The stored system may include a storage server application programming interface (API) 174, the storage 172, storage metadata 127, and a compactor 122.

The stored content or portions thereof may be stored in the storage 172, which may be accessed by the computing device 110 directly or indirectly via the packager 124 to deliver the stored content to the computing device 110. The storage of the content or portions thereof may occur after the linear packager 106 processes the content. The storage 172 may comprise cloud object storage and/or one or more data storage devices, such as volatile memory (e.g., one or more of random access memory (RAM)), a hard disk drive, a network-attached storage (NAS), a storage area network (SAN), SATA drive, a solid state drive (SSD), or a non-volatile memory express (NVMe) drive upon which the content or portions thereof may be stored.

The storage server API 174 may facilitate communications and data transfer between the storage system 171 and the content delivery system 171, the scheduler 180, or a combination thereof. For example, the API 174 may facilitate communications between the storage system 171 and the video recording system 123 (e.g., recorded content sent from the video recording system 123 to the storage system 171), between the storage system 171 and the video origin 125 (e.g., stored content from the storage system 171 sent to the video origin 125 for eventual playback), and between the storage system 171 and the scheduler 180 (e.g., the scheduler 180 sending requests for video playback or deletion of stored content).

The compactor 122 may compact aggregated content according to deletion requests received from computing devices (e.g., computing device 110 and/or other computing devices), which will be discuss in more detail below. In some cases, the compactor 110 may generate aggregated content. For example, the compactor 122 may receive multiple content segments (e.g., from storage 172) and may generate a aggregated content based on the multiple content segments. The compactor 122 may send the aggregated content to the storage 172 for storage. The compactor 122 may also compact previously stored aggregated content based on determining a compaction trigger (e.g., a number of deletion requests for content segments of the aggregated content exceeds a threshold number or threshold percentage of user-specific content segments). In some cases, the compactor may receive instructions for modifying the aggregated content, such as by the video origin 125. The compactor may recreate new segments (user-specific content segments) by reading the header segments (e.g., system level objects). By reading the header segments as opposed to the user-specific content segments prior to compaction, less resources (e.g., bytes, input/output operations, and the like) of the system may be utilized.

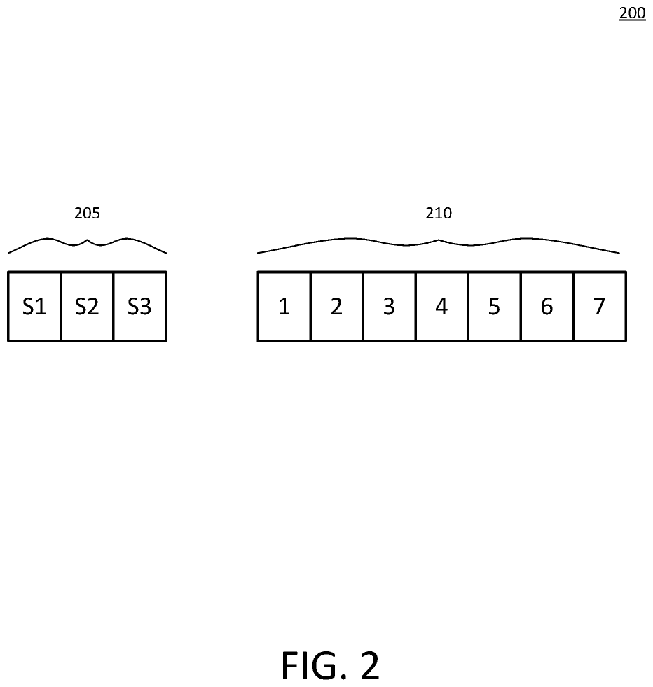

FIG. 2 depicts an aggregated content 200 according to the present disclosure. The aggregated content 200 may be stored for users to access, such as in storage 172. An aggregated content (e.g., a content segment grouping) 200 may comprise a combination of header segments 205 and user-specific content segments 210 for a representation of a unique recording. One or more content segment groupings may be associated with the unique portion of the recording for the computing device 110.

The user-specific content segments 210 may include portions of a bitstream associated with the content. For example, a user-specific content segment may comprise a portion of content (e.g., a 2-second chunk of content such as video content). Each of the user-specific content segments may be limited to a user account. In some cases, each of the user-specific content segments 210 may be associated with a header segment of the header segments. For example, user-specific content segments 1-3 may be associated with header segment S1, where each user-specific content 1-3 may be stored for a different user. In some cases, the user-specific content 1-3 may be a same content segment stored for different users (e.g., the same 2-second chunk of segment of a content). In some cases, the user-specific content 1-3 may be different content segments stored for different users (e.g., different 2-second chunk of segments of a content). Likewise, the user-specific content 4-5 may be associated with header segment S2, and the user-specific content 6-7 may be associated with header segment S3. In some cases, the segment headers 205 may correspond to the same content segment, or to different content segments. For example, some of the segment headers S1-S3 may correspond to a same content segment. In another example, some of the segment headers S1-S3 may correspond to different content segments.

In some cases, header segments 205 may comprise metadata associated with the content segments stored as user-specific content segments 205 of the content. In some cases, the header segments may comprise content segments stored for rewriting corresponding user-specific content segments 210. For example, a header segment 205 may comprise a byte copy of an associated content segment. In some cases, the header segments 205 may comprise system level data objects, which can store information with the content segments 210 and can be used for the recreation of the content segments 210. For example, a header segment may include metadata indicative of characteristics of the content. For example, the header segment may contain size information of the associated content, or of the user-specific content segments associated with the header segment. For example, the header segment S1 of FIG. 2 may include size information for the content segments 1-3. In some cases, a header segment may include information related to identifying which user-specific content segments are associated with that header segment. In some cases, a header segment may include information indicative of the size of that particular header segment, or of the header segments 205. An example header segment entry may include:

| type Header struct | { |
|---|---|
| headerSize unit32 | |
| segments | [ ]Segment |
| } | |
| type Segment struct | { |

```
  size uint32
  segment [ ]byte
}
```

The header segments 205 may be accessible by other components of the system 100 (e.g., the compactor 122, the video recording system 123, the video origin 125, etc.). When a request for a content segment is received, such as from the computing device 110, the storage system 171 may access the content segment grouping (e.g., stored in storage 172) indicated in the request, may identify the user-specific content segment according to the associated header segment, and may package the user-specific content segment for returning to the computer device 110.

In some cases, the storage system 171 may receive requests for deletion of user-specific content segments from the computing device 110. For example, a request to delete a user-specific content may be received from the computing device 110 (or another computing device). The storage system 171 may relay this request to metadata storage 127, compactor 122, or both, and metadata storage 127 may store this request for deletion. Typically, compactor 122 may receive the request for deletion and rewrite the associated aggregated content, which may waste processing resources.

According to the present disclosure, the compactor 122 may monitor the number of deletion requests for a aggregated content. For example, the compactor 122 may access the metadata storage 127 (e.g., upon arrival of a request for deletion for a particular user-specific content segment). The compactor 122 may determine a number of requests for deletion of user-specific content segments for the group of content segments. The compactor 122 may determine whether the number of requests for deletion matches or exceeds a predefined compaction threshold. If the number of deletion requests matches or exceeds the threshold, the compactor 122 may execute a compaction process on the aggregated content. The compaction process may include determining the identity of the user-specific content segments requested for deletion, and generating a new aggregated content that does not include the identified user-specific content segments. The compaction process may also include the header segments from the previous aggregated content (e.g. the aggregated content that underwent the compaction process). The compactor 122 may send or write the aggregated content to storage 172. The original aggregated content, from which the compaction is performed, may be deleted from storage 172, or overwritten with the compacted aggregated content from the compactor 122. In cases where the number of deletion requests for the aggregated content fails to exceed or match the threshold, the compactor 122 may refrain from performing a compaction process on the aggregated content.

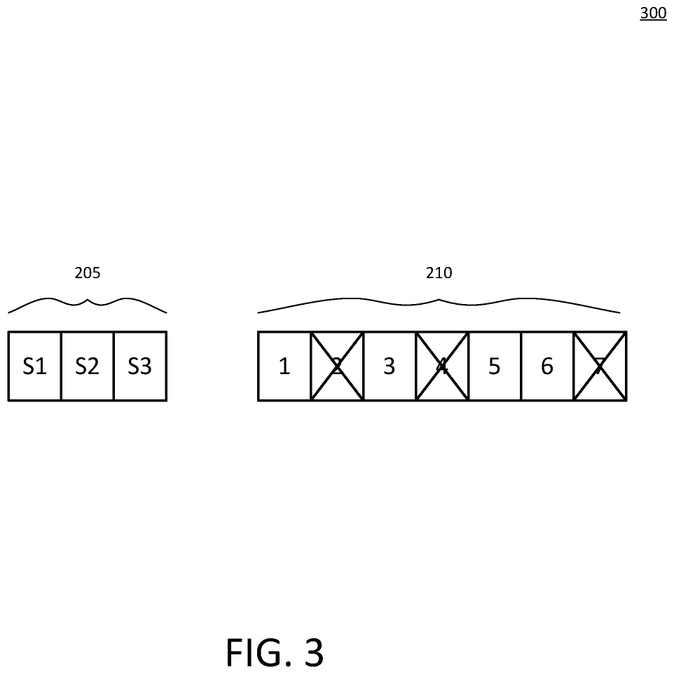

FIG. 3 depicts an aggregated content 300 according to the present disclosure. The aggregated content 300 may include header segments 205 and user-specific content segments 210. The aggregated content 300 may be an example of aggregated content 200 of FIG. 2, with header segments 205 and user-specific content segments 210. In the example of FIG. 3, the content delivery system 170 may receive deletion requests for user-specific content segments 2, 4, and 7 (e.g., from computing device 110 and/or other computing devices). Information of these deletion requests may be store (e.g., as metadata) in metadata store 127. The user-specific content segments associated with the deletion requests may be marked or flagged for deletion. In the example of FIG. 3, user-specific content segments 2, 4, and 7 have been marked for deletion. This marking may be stored in metadata store 127 as metadata associated with the aggregated content 300.

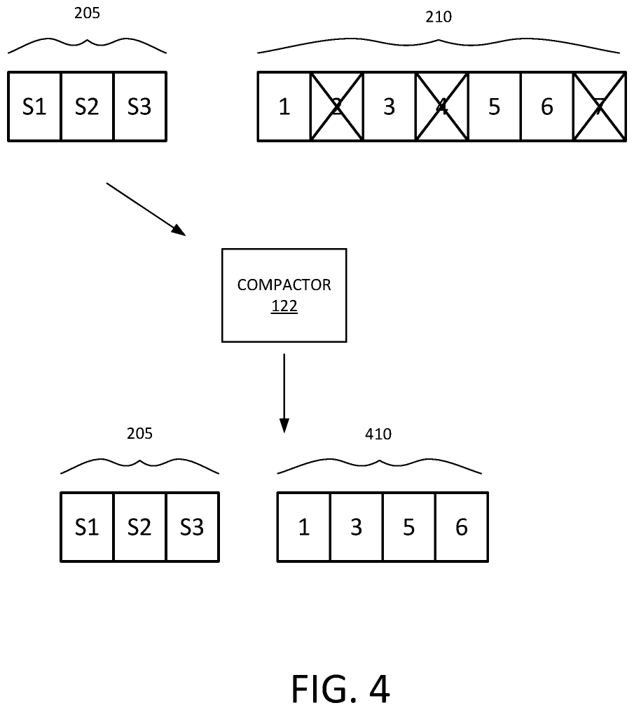

FIG. 4 depicts a compaction process according to the present disclosure. The compactor 122 may identify which user-specific content segments of the user-specific content segments, such as by retrieving metadata (e.g., from metadata store 127) that is indicative of received deletion requests. If the number of deletions match or exceed a predefined compaction threshold, the compactor 122 may perform a compaction process on the aggregated content. For example, the compactor 122 may remove the user-specific content segments associated with a deletion request for the aggregated content. In some cases, the compactor 122 may generate a new aggregated content that does not include the user-specific content segments associated with a deletion request (via concatenation). In the example of FIG. 4, the compactor may generate an aggregated content comprised of the header segment 205 and updated user-specific content segments 410, which can include the user-specific content segments that were not indicated (e.g., in metadata) to be associated with a deletion request received by the content delivery system 170. For example, the updated user-specific content segments 410 can include user-specific content segments 1, 3, 5, and 6, where segments 2 and 4 of the user-specific content segments 210 were removed (or not included) during the compaction process performed by the compactor 122. The compactor may recreate the new segments (user-specific content segments 410) by reading the header segments (e.g., system level objects) 205. The compacted aggregated content may then be stored in storage 172, and metadata associated with the compacted aggregated content may be updated (e.g., the metadata of the previous version of the aggregated content may be overwritten by data indicative of characteristics of the compacted aggregated content, and/or the deletion requests for the previous version of the aggregated content may be deleted). By reading the header segments 205 as opposed to the user-specific content segments prior to compaction, less resources (e.g., bytes, input/output operations, and the like) of the system may be utilized. Further, cases where no remaining user-specific content segment, associated with a particular header segment, is recreated during the compaction process, the compactor may also refrain from rewriting the particular segment header. So for example, if, in FIG. 4. the user-specific content segments 6 and 7 associated with S3 are scheduled to not be rewritten during compaction, the S3 segment header may also not be rewritten during the compaction process.

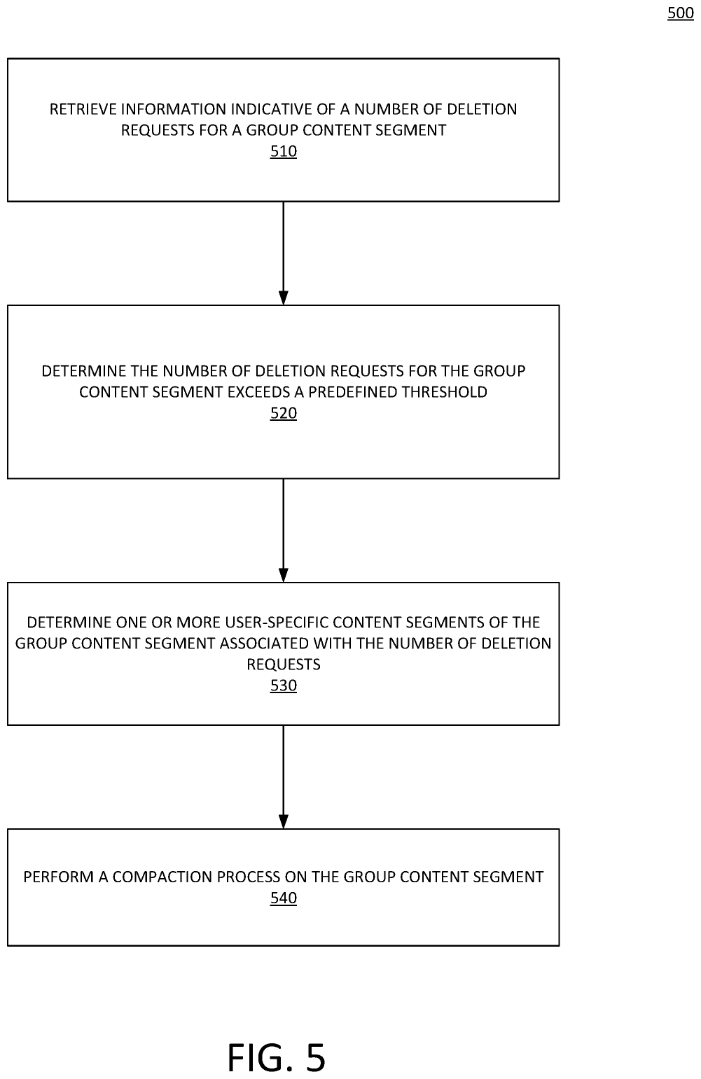

FIG. 5 shows an example method 500. The method 500 of FIG. 5 may be performed by a compactor described herein. While each step in the method 500 of FIG. 5 is shown and described separately, multiple steps may be executed in a different order than what is shown, in parallel with each other, or concurrently with each other.

At step 510, information indicative of a number of deletion requests received for a aggregated content comprising a plurality of user-specific content segments may be received. In some cases, the compactor may retrieve the information from a metadata store. In some cases, the compactor may initiate the retrieval based on a deletion request being received by a content recording system which is associated with the compactor.

At step 520, the number of deletion requests for the aggregated content may be determined to exceed a predefined compaction threshold. The compaction threshold may be dependent on a size of the aggregated content (e.g., the number of user-specific content segments included in the aggregated content). For example, the predefined compaction threshold may be 40% of the user-specific content segments, or 50%, or 60%. In some cases, the predefined compaction threshold may be a number of user-specific content segments. For example, the predefined compaction threshold may be 3 user-specific content segments, or 60 user-specific content segment, etc.

At step 530, one or more user-specific content segments of the plurality of user-specific content segments that are associated with the number of deletion requests may be identified. The information retrieved (in step 510) may include identification information of the user-specific content segments requested for deletion. For example, particular user-specific content segments may be marked or flagged for deletion in the retrieved information.

At step 540, a compaction process may be performed on the aggregated content. The compaction process may result in a compacted aggregated content. The compacted aggregated content may include user-specific content segments from uncompacted aggregated content, with the user-specific content segments removed. The compacted aggregated content may also include the header segments from the uncompacted aggregated content. The compacted aggregated content may replace or overwrite the uncompacted aggregated content in storage, and the information indicative of the number of deletion request may be overwritten.

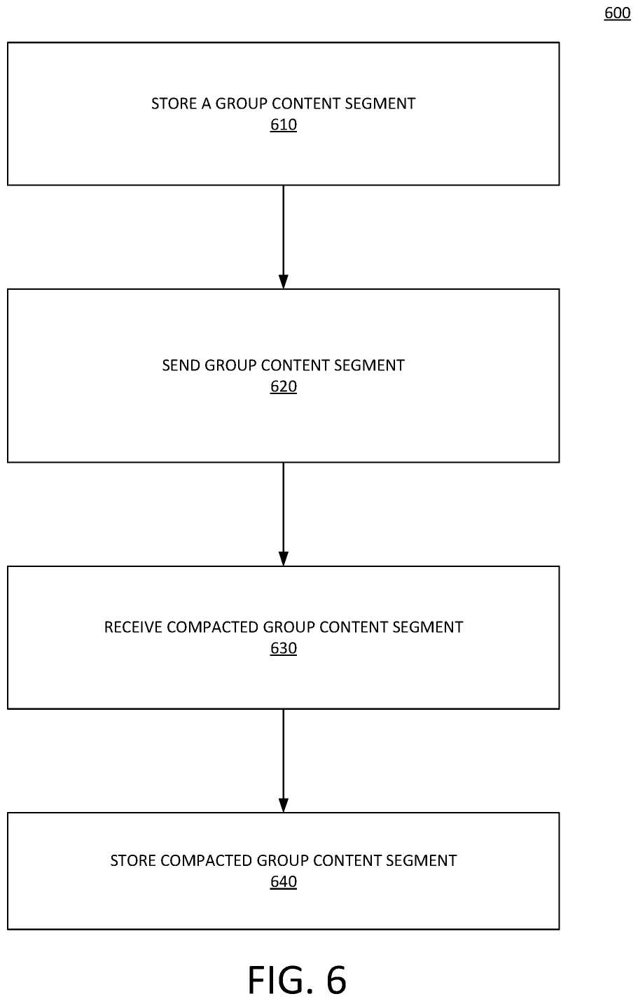

FIG. 6 shows an example method 600. The method 600 of FIG. 6 may be performed by a computing device described herein. While each step in the method 600 of FIG. 6 is shown and described separately, multiple steps may be executed in a different order than what is shown, in parallel with each other, or concurrently with each other.

At step 610, a aggregated content may be stored. The aggregated content may be stored in storage of a content recording system. The aggregated content may include user-specific content segments for one or more computing devices.

At step 620, the aggregated content may be accessed or retrieved from storage. The retrieval may occur via a compactor associated with the content recording system. The retrieval may be triggered by a request for deletion received by the content recording system and from a computing device.

At step 630, a compacted aggregated content may be received. The compacted aggregated content may include user-specific content segments from uncompacted aggregated content, with the user-specific content segments removed. The compacted aggregated content may also include the header segments from the uncompacted aggregated content. A compaction process for compacting the aggregated content may be based on a number of deletion requests received for the aggregated content exceeding a predefined compaction threshold. The compaction threshold may be dependent on a size of the aggregated content (e.g., the number of user-specific content segments included in the aggregated content). For example, the predefined compaction threshold may be 40% of the user-specific content segments, or 50%, or 60%. In some cases, the predefined compaction threshold may be a number of user-specific content segments.

At step 640, the compacted aggregated content may be stored in storage. The compacted aggregated content may replace or overwrite the uncompacted aggregated content in storage, and the information indicative of the number of deletion request may be overwritten.

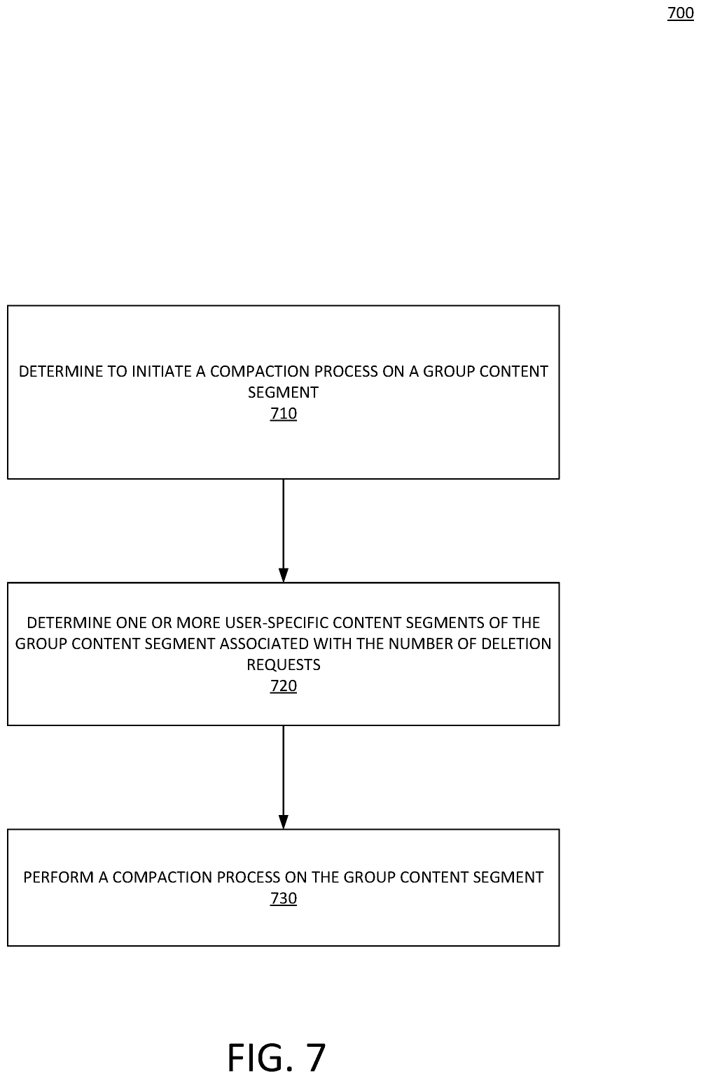

FIG. 7 shows an example method 700. The method 700 of FIG. 7 may be performed by a compactor described herein. While each step in the method 700 of FIG. 7 is shown and described separately, multiple steps may be executed in a different order than what is shown, in parallel with each other, or concurrently with each other.

At step 710, the compactor may determine to initiate a compaction process on a aggregated content. In some cases, the determination may be based on a number of deletion requests received for one or more content segments stored in the aggregated content. For example, the determination may be based on a number of deletion requests received for the aggregated content exceeding a predefined compaction threshold. The compaction threshold may be dependent on a size of the aggregated content (e.g., the number of user-specific content segments included in the aggregated content). For example, the predefined compaction threshold may be 40% of the user-specific content segments, or 50%, or 60%. In some cases, the predefined compaction threshold may be a number of user-specific content segments. For example, the predefined compaction threshold may be 3 user-specific content segments, or 60 user-specific content segments, etc.

At step 720, one or more user-specific content segments of the plurality of user-specific content segments that are associated with the number of deletion requests may be identified. In some cases, identification information of user-specific content segments requested for deletion may be retrieved from metadata storage. For example, particular user-specific content segments may be marked or flagged for deletion in the retrieved information.

At step 730, a compaction process may be performed on the aggregated content. The compaction process may result in a compacted aggregated content. The compacted aggregated content may include user-specific content segments from the uncompacted aggregated content, with the user-specific content segments removed. The compacted aggregated content may also include the header segments from the uncompacted aggregated content. The compacted aggregated content may replace or overwrite the uncompacted aggregated content in storage, and the information indicative of the number of deletion request may be overwritten.

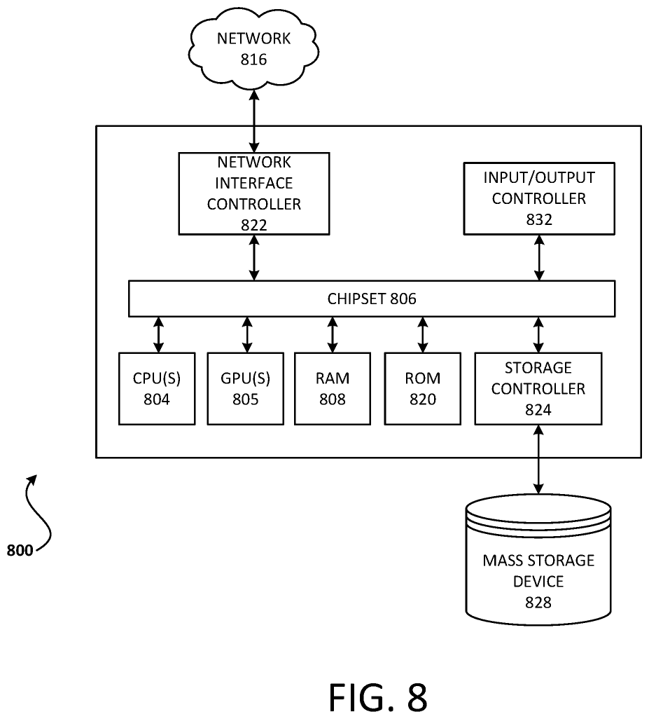

FIG. 8 depicts a computing device 800 that may be used in various aspects, such as the servers, compactors, computing devices, and other devices depicted in FIG. 1. With regard to the example architectures of FIG. 1, the devices may each be implemented in an instance of a computing device 800 of FIG. 8. The computer architecture shown in FIG. 8 shows a conventional server computer, workstation, desktop computer, laptop, tablet, network appliance, PDA, e-reader, digital cellular phone, or other computing node, and may be utilized to execute any aspects of the computers described herein, such as to implement the methods described in relation to FIGS. 4-7.

The computing device 800 may include a baseboard, or “motherboard,” which is a printed circuit board to which a multitude of components or devices may be connected by way of a system bus or other electrical communication paths. One or more central processing units (CPUs) 804 may operate in conjunction with a chipset 806. The CPU(s) 804 may be standard programmable processors that perform arithmetic and logical operations necessary for the operation of the computing device 800.

The CPU(s) 804 may perform the necessary operations by transitioning from one discrete physical state to the next through the manipulation of switching elements that differentiate between and change these states. Switching elements may generally include electronic circuits that maintain one of two binary states, such as flip-flops, and electronic circuits that provide an output state based on the logical combination of the states of one or more other switching elements, such as logic gates. These basic switching elements may be combined to create more complex logic circuits including registers, adders-subtractors, arithmetic logic units, floating-point units, and the like.

The CPU(s) 804 may be augmented with or replaced by other processing units, such as GPU(s) 805. The GPU(s) 805 may comprise processing units specialized for but not necessarily limited to highly parallel computations, such as graphics and other visualization-related processing.

A chipset 806 may provide an interface between the CPU(s) 804 and the remainder of the components and devices on the baseboard. The chipset 806 may provide an interface to a random access memory (RAM) 808 used as the main memory in the computing device 800. The chipset 806 may further provide an interface to a computer-readable storage medium, such as a read-only memory (ROM) 820 or non-volatile RAM (NVRAM) (not shown), for storing basic routines that may help to start up the computing device 800 and to transfer information between the various components and devices. ROM 820 or NVRAM may also store other software components necessary for the operation of the computing device 800 in accordance with the aspects described herein.

The computing device 800 may operate in a networked environment using logical connections to remote computing nodes and computer systems through local area network (LAN) 816. The chipset 806 may include functionality for providing network connectivity through a network interface controller (NIC) 822, such as a gigabit Ethernet adapter. A NIC 822 may be capable of connecting the computing device 800 to other computing nodes over a network 816. It should be appreciated that multiple NICs 822 may be present in the computing device 800, connecting the computing device to other types of networks and remote computer systems.

The computing device 800 may be connected to a mass storage device 828 that provides non-volatile storage for the computer. The mass storage device 828 may store system programs, application programs, other program modules, and data, which have been described in greater detail herein. The mass storage device 828 may be connected to the computing device 800 through a storage controller 824 connected to the chipset 806. The mass storage device 828 may consist of one or more physical storage units. A storage controller 824 may interface with the physical storage units through a serial attached SCSI (SAS) interface, a SATA interface, a fiber channel (FC) interface, or other type of interface for physically connecting and transferring data between computers and physical storage units.

The computing device 800 may store data on a mass storage device 828 by transforming the physical state of the physical storage units to reflect the information being stored. The specific transformation of a physical state may depend on various factors and on different implementations of this description. Examples of such factors may include, but are not limited to, the technology used to implement the physical storage units and whether the mass storage device 828 is characterized as primary or secondary storage and the like.

For example, the computing device 800 may store information to the mass storage device 828 by issuing instructions through a storage controller 824 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit. Other transformations of physical media are possible without departing from the scope and spirit of the present description, with the foregoing examples provided only to facilitate this description. The computing device 800 may further read information from the mass storage device 828 by detecting the physical states or characteristics of one or more particular locations within the physical storage units.

In addition to the mass storage device 828 described herein, the computing device 800 may have access to other computer-readable storage media to store and retrieve information, such as program modules, data structures, or other data. It should be appreciated by those skilled in the art that computer-readable storage media may be any available media that provides for the storage of non-transitory data and that may be accessed by the computing device 800.

By way of example and not limitation, computer-readable storage media may include volatile and non-volatile, transitory computer-readable storage media and non-transitory computer-readable storage media, and removable and non-removable media implemented in any method or technology. Computer-readable storage media includes, but is not limited to, RAM, ROM, erasable programmable ROM (“EPROM”), electrically erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage, other magnetic storage devices, or any other medium that may be used to store the desired information in a non-transitory fashion.

A mass storage device, such as the mass storage device 828 depicted in FIG. 8, may store an operating system utilized to control the operation of the computing device 800. The operating system may comprise a version of the LINUX operating system. The operating system may comprise a version of the WINDOWS SERVER operating system from the MICROSOFT Corporation. According to further aspects, the operating system may comprise a version of the UNIX operating system. Various mobile phone operating systems, such as IOS and ANDROID, may also be utilized. It should be appreciated that other operating systems may also be utilized. The mass storage device 828 may store other system or application programs and data utilized by the computing device 800.

The mass storage device 828 or other computer-readable storage media may also be encoded with computer-executable instructions, which, when loaded into the computing device 800, transforms the computing device from a general-purpose computing system into a special-purpose computer capable of implementing the aspects described herein. These computer-executable instructions transform the computing device 800 by specifying how the CPU(s) 804 transition between states, as described herein. The computing device 800 may have access to computer-readable storage media storing computer-executable instructions, which, when executed by the computing device 800, may perform the methods described in relation to FIGS. 2-7.

A computing device, such as the computing device 800 depicted in FIG. 8, may also include an input/output controller 832 for receiving and processing input from a number of input devices, such as a keyboard, a mouse, a touchpad, a touch screen, an electronic stylus, or other type of input device. Similarly, an input/output controller 832 may provide output to a display, such as a computer monitor, a flat-panel display, a digital projector, a printer, a plotter, or other type of output device. It will be appreciated that the computing device 800 may not include all of the components shown in FIG. 8, may include other components that are not explicitly shown in FIG. 8, or may utilize an architecture completely different than that shown in FIG. 8.

As described herein, a computing device may be a physical computing device, such as the computing device 800 of FIG. 8. A computing node may also include a virtual machine host process and one or more virtual machine instances. Computer-executable instructions may be executed by the physical hardware of a computing device indirectly through interpretation and/or execution of instructions stored and executed in the context of a virtual machine.

It is to be understood that the methods and systems described herein are not limited to specific methods, specific components, or to particular implementations. It is also to be understood that the terminology used herein is for the purpose of describing particular embodiments only and is not intended to be limiting.

As used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other components, integers or steps. “Exemplary” means “an example of” and is not intended to convey an indication of a preferred or ideal embodiment. “Such as” is not used in a restrictive sense, but for explanatory purposes.

Components are described that may be used to perform the described methods and systems. When combinations, subsets, interactions, groups, etc., of these components are described, it is understood that while specific references to each of the various individual and collective combinations and permutations of these may not be explicitly described, each is specifically contemplated and described herein, for all methods and systems. This applies to all aspects of this application including, but not limited to, operations in described methods. Thus, if there are a variety of additional operations that may be performed it is understood that each of these additional operations may be performed with any specific embodiment or combination of embodiments of the described methods.

The present methods and systems may be understood more readily by reference to the following detailed description of preferred embodiments and the examples included therein and to the Figures and their descriptions.

As will be appreciated by one skilled in the art, the methods and systems may take the form of an entirely hardware embodiment, an entirely software embodiment, or an embodiment combining software and hardware aspects. Furthermore, the methods and systems may take the form of a computer program product on a computer-readable storage medium having computer-readable program instructions (e.g., computer software) embodied in the storage medium. More particularly, the present methods and systems may take the form of web-implemented computer software. Any suitable computer-readable storage medium may be utilized including hard disks, CD-ROMs, optical storage devices, or magnetic storage devices.

Embodiments of the methods and systems are described herein with reference to block diagrams and flowchart illustrations of methods, systems, apparatuses and computer program products. It will be understood that each block of the block diagrams and flowchart illustrations, and combinations of blocks in the block diagrams and flowchart illustrations, respectively, may be implemented by computer program instructions. These computer program instructions may be loaded on a general-purpose computer, special-purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that may direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

The various features and processes described herein may be used independently of one another, or may be combined in various ways. All possible combinations and sub-combinations are intended to fall within the scope of this disclosure. In addition, certain methods or process blocks may be omitted in some implementations. The methods and processes described herein are also not limited to any particular sequence, and the blocks or states relating thereto may be performed in other sequences that are appropriate. For example, described blocks or states may be performed in an order other than that specifically described, or multiple blocks or states may be combined in a single block or state. The example blocks or states may be performed in serial, in parallel, or in some other manner. Blocks or states may be added to or removed from the described example embodiments. The example systems and components described herein may be configured differently than described. For example, elements may be added to, removed from, or rearranged compared to the described example embodiments.

It will also be appreciated that various items are illustrated as being stored in memory or on storage while being used, and that these items or portions thereof may be transferred between memory and other storage devices for purposes of memory management and data integrity. Alternatively, in other embodiments, some or all of the software modules and/or systems may execute in memory on another device and communicate with the illustrated computing systems via inter-computer communication. Furthermore, in some embodiments, some or all of the systems and/or modules may be implemented or provided in other ways, such as at least partially in firmware and/or hardware, including, but not limited to, one or more application-specific integrated circuits (“ASICs”), standard integrated circuits, controllers (e.g., by executing appropriate instructions, and including microcontrollers and/or embedded controllers), field-programmable gate arrays (“FPGAs”), complex programmable logic devices (“CPLDs”), etc. Some or all of the modules, systems, and data structures may also be stored (e.g., as software instructions or structured data) on a computer-readable medium, such as a hard disk, a memory, a network, or a portable media article to be read by an appropriate device or via an appropriate connection. The systems, modules, and data structures may also be transmitted as generated data signals (e.g., as part of a carrier wave or other analog or digital propagated signal) on a variety of computer-readable transmission media, including wireless-based and wired/cable-based media, and may take a variety of forms (e.g., as part of a single or multiplexed analog signal, or as multiple discrete digital packets or frames). Such computer program products may also take other forms in other embodiments. Accordingly, the present invention may be practiced with other computer system configurations.

While the methods and systems have been described in connection with preferred embodiments and specific examples, it is not intended that the scope be limited to the particular embodiments set forth, as the embodiments herein are intended in all respects to be illustrative rather than restrictive.

Unless otherwise expressly stated, it is in no way intended that any method set forth herein be construed as requiring that its operations be performed in a specific order. Accordingly, where a method claim does not actually recite an order to be followed by its operations or it is not otherwise specifically stated in the claims or descriptions that the operations are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; and the number or type of embodiments described in the specification.

It will be apparent to those skilled in the art that various modifications and variations may be made without departing from the scope or spirit of the present disclosure. Other embodiments will be apparent to those skilled in the art from consideration of the specification and practices described herein. It is intended that the specification and example figures be considered as exemplary only, with a true scope and spirit being indicated by the following claims.

What is claimed:

1. A method comprising:
determining, by a computing device, a quantity of deletion requests for an aggregated content satisfies a threshold, wherein the aggregated content comprises a plurality of user-specific content segments and one or more header segments corresponding to the plurality of user-specific content segments;
generating a new aggregated content comprising a subset of the plurality of the user-specific content segments and at least one of the one or more header segments, wherein each of the subset of the plurality of user-specific content segments are not identified for deletion in the quantity of deletion requests; and
causing to be stored the new aggregated content in storage.

2. The method of claim 1, further comprising:
retrieving, by the computing device, information indicative of the quantity of deletion requests received for the aggregated content.

3. The method of claim 2, further comprising:
receiving, by the computing device, information indicative of a deletion request received by a content recording system associated with the computing device, wherein the retrieving the information indicative of the quantity of deletion requests is based on the receiving.

4. The method of claim 2, wherein the information indicative of the quantity of deletion requests comprises metadata corresponding to a quantity of deletion requests received for each of the plurality of user-specific content segments.

5. The method of claim 1, wherein the threshold comprises a fraction of a total number of the plurality of user-specific content segments.

6. The method of claim 1, wherein causing to be stored the new aggregated content in storage comprises replacing the aggregated content with the new aggregated content.

7. The method of claim 1, wherein the deletion requests are received from one or more user devices.

8. The method of claim 1, wherein the one or more header segments comprise system level data objects for generating the plurality of user-specific content segments.

9. The method of claim 1, further comprising:
determining a subset of the one or more header segments correspond to user-specific content segments associated with the a quantity of deletion requests; and
deleting the subset of the one or more header segments from the new aggregated content.

10. An apparatus, comprising:
one or more processors, memory, and computer-executable instructions stored in the memory that, when executed, cause:
determining, by the apparatus, a quantity of deletion requests for an aggregated content satisfies a threshold, wherein the aggregated content comprises a plurality of user-specific content segments and one or more header segments corresponding to the plurality of user-specific content segments;
generating a new aggregated content comprising a subset of the plurality of the user-specific content segments and at least one of the one or more header segments, wherein each of the subset of the plurality of user-specific content segments are not identified for deletion in the quantity of deletion requests; and
causing to be stored the new aggregated content in storage.

11. The apparatus of claim 10, wherein the computer-executable instructions, when executed, further cause:
retrieving, by the apparatus, information indicative of the quantity of deletion requests received for the aggregated content.

12. The apparatus of claim 11, wherein the computer-executable instructions, when executed, further cause:
receiving, by the apparatus, information indicative of a deletion request received by a content recording system associated with the apparatus, wherein the retrieving the information indicative of the quantity of deletion requests is based on the receiving.

13. The apparatus of claim 11, wherein the information indicative of the quantity of deletion requests comprises metadata corresponding to a quantity of deletion requests received for each of the plurality of user-specific content segments.

14. The apparatus of claim 10, wherein the threshold comprises a fraction of a total number of the plurality of user-specific content segments.

15. The apparatus of claim 10, wherein causing to be stored the new aggregated content in storage comprises replacing the aggregated content with the new aggregated content.

16. The apparatus of claim 10, wherein the deletion requests are received from one or more user devices.

17. The apparatus of claim 10, wherein the one or more header segments comprise system level data objects for generating the plurality of user-specific content segments.

18. The apparatus of claim 10, wherein the computer-executable instructions, when executed, further cause:
determining a subset of the one or more header segments corresponding to user-specific content segments associated with the quantity of deletion requests; and
deleting the subset of the one or more header segments from the new aggregated content.

19. A non-transitory, computer-readable medium storing instructions that, when executed, cause:
determining, by a computing device, a quantity of deletion requests for an aggregated content satisfies a threshold, wherein the aggregated content comprises a plurality of user-specific content segments and one or more header segments corresponding to the plurality of user-specific content segments;
generating a new aggregated content comprising a subset of the plurality of the user-specific content segments and at least one of the one or more header segments, wherein each of the subset of the plurality of user-specific content segments are not identified for deletion in the quantity of deletion requests; and
causing to be stored the new aggregated content in storage.

20. The non-transitory, computer-readable medium of claim 19, wherein the instructions, when executed, further cause:
retrieving, by the computing device, information indicative of the quantity of deletion requests received for the aggregated content.

21. The non-transitory, computer-readable medium of claim 20, wherein the instructions, when executed, further cause:
receiving, by the computing device, information indicative of a deletion request received by a content recording system associated with the computing device, wherein the retrieving the information indicative of the quantity of deletion requests is based on the receiving.

22. The non-transitory, computer-readable medium of claim 20, wherein the information indicative of the quantity of deletion requests comprises metadata corresponding to a quantity of deletion requests received for each of the plurality of user-specific content segments.

23. The non-transitory, computer-readable medium of claim 19, wherein the threshold comprises a fraction of a total number of the plurality of user-specific content segments.

24. The non-transitory, computer-readable medium of claim 19, wherein causing to be stored the new aggregated content in storage comprises replacing the aggregated content with the new aggregated content.

25. The non-transitory, computer-readable medium of claim 19, wherein the deletion requests are received from one or more user devices.

26. The non-transitory, computer-readable medium of claim 19, wherein the one or more header segments comprise system level data objects for generating the plurality of user-specific content segments.

27. The non-transitory, computer-readable medium of claim 19, wherein the instructions, when executed, further cause:
determining a subset of the one or more header segments corresponding to user-specific content segments associated with the quantity of deletion requests; and
deleting the subset of the one or more header segments from the new aggregated content.
